(19) United States
(12) Patent Application Publication
(10) Pub. No.: US 2010/0255378 A1
(43) Pub. Date: Oct. 7, 2010

(54) VINYLIDENE FLUORIDE COPOLYMER FUNCTIONALIZED BY RADIATION GRAFTING OF AN UNSATURATED POLAR MONOMER

(76) Inventors: Anthony Bonnet, Beaumont Le Roger (FR); Aude Lapprand, Paris (FR); Pascal Sebire, Sant-Aubin le Vertueux (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 12/376,654

(22) PCT Filed: Jul. 7, 2007
(86) PCT No.: PCT/FR07/51791

§ 371 Date: Jun. 8, 2010

(30) Foreign Application Priority Data
Aug. 8, 2006 (FR) 0653316

(51) Int. Cl. H01M 4/58; C08F 214/22; B32B 27/08; B32B 1/08; B32B 1/00

(52) U.S. Cl. 429/231.95; 525/326.3; 428/421; 428/412; 428/36.91; 428/35.7

(57) ABSTRACT

The invention relates to a copolymer of VDF and at least one monomer that is copolymerizable with VDF, having a VDF weight content of at least 50%, preferably at least 75%, onto which at least one unsaturated polar monomer is radiation grafted, characterized in that the VDF copolymer has, before grafting, the following characteristics:
a crystallization temperature T_{c} (measured by DSC according to the standard ISO 11357-3) ranging from 50 to 120° C., preferably from 85 to 110° C.;
a yield strength σ_{Y} ranging from 10 to 40 MPa, preferably from 10 to 30 MPa; and
a melt viscosity η (measured with a capillary rheometre at 230° C. and 100 s⁻¹) ranging from 100 to 1500 Pa·s, preferably from 400 to 1200 Pa·s.

The invention also relates to a blend comprising this modified copolymer and a PVDF.

This modified copolymer or the blend may be combined with a thermoplastic polymer, an elastomer or an inorganic material.

### FIELD OF THE INVENTION

The invention relates to a functionalized PVDF that is obtained by radiation grafting of at least one unsaturated polar monomer onto a PVDF, and also to a blend comprising this functionalized PVDF and an unmodified PVDF. The functionalized PVDF or the blend have the feature of adhering to many materials such as thermoplastic polymers or inorganic materials, which makes it possible to obtain multilayer structures. The invention also relates to these multilayer structures and also to a coextrusion process in which a layer of the functionalized PVDF or of the blend is coextruded.

### THE TECHNICAL PROBLEM

PVDF is known to offer excellent mechanical stability properties, very high chemical inertness and also good ageing resistance. These qualities are exploited in various fields of application. Mention may be made, for example, of the manufacture of extruded or injection-moulded parts for the chemical engineering industry or for microelectronics, its use in the form of impermeable ducting for the transport of gases or hydrocarbons, the formation of protective films or coatings in the architectural field and the production of protective components for electrical engineering uses. However, it is also known that it is difficult to make PVDF adhere to other materials.

European applications EP 1 484 346, EP 1 537 989, EP 1 541 343 or international applications WO 2006/045630 or WO 2006/042764 describe a method for modifying a fluoropolymer, especially PVDF, enabling the fluoropolymer to be adhered onto thermoplastic polymers or onto inorganic materials. The method consists in radiation grafting an unsaturated polar monomer. The Applicant has observed that the adhesion may be greatly increased if the fluoropolymer that is modified by this method is a particular PVDF copolymer having certain thermal and mechanical characteristics. The Applicant has also observed that it is possible to obtain a higher coextrusion line speed in the presence of this functionalized PVDF.

### THE PRIOR ART

European application EP 1 101 994 describes a fuel hose comprising a layer of a functionalized fluoropolymer. The latter may be a fluoropolymer functionalized by radiation grafting.

European applications EP 1 484 346, EP 1 537 989, EP 1 541 343, EP 1 637 319 describe a method for modifying a fluoropolymer, especially PVDF, consisting in radiation grafting an unsaturated polar monomer. The PVDF may be a homopolymer or copolymer.

International application WO 2006/045630 describes a blend of a functionalized PVDF and a flexible fluoropolymer having a viscosity η between 100 and 1500 Pa·s, a crystallization temperature T_{c} between 50 and 120° C. The functionalized PVDF is preferably obtained by radiation grafting and comprises preferably more than 80 mol % of VDF, even better it is a homopolymer.

Application EP 1 508 927 describes examples of functionalized PVDF used alone or in a blend. In the examples, the grades KYNARFLEX® 2801 or KYNAR® 761 are used. The KYNARFLEX® 2801 that is modified is a VDF-HFP copolymer and has the following characteristics: 11% of HFP, a σ_{Y} between 20 and 34 MPa, a T_{c} of 116.8° C. and a viscosity η of around 2500 Pa·s (230° C., 100 s⁻¹). KYNAR® 761 is a PVDF homopolymer. The grade 2801 is more viscous than the PVDF which is modified according to the invention. After the radiation step, the PVDF has a certain degree of crosslinking connected to the fact that it creates crosslinking points between the PVDF chains: this has the effect of further increasing the melt viscosity, which makes the functionalized PVDF more difficult to convert and to use whether it is in the melt state or else in solution in a solvent.

There is no reference to PVDF having the thermal and mechanical characteristics of the invention in any of these documents.

### BRIEF DESCRIPTION OF THE INVENTION

The invention relates to a copolymer of VDF and at least one monomer that is copolymerizable with VDF, having a VDF weight content of at least 50%, preferably at least 75%, onto which at least one unsaturated polar monomer is radiation grafted, characterized in that the VDF copolymer has, before grafting, the following characteristics:
a crystallization temperature T_{c} (measured by DSC according to the standard ISO 11357-3) ranging from 50 to 120° C., preferably from 85 to 110° C.;
a yield strength σ_{Y} ranging from 10 to 40 MPa, preferably from 10 to 30 MPa; and
a melt viscosity η (measured with a capillary rheometer at 230° C. and 100 s⁻¹) ranging from 100 to 1500 Pa·s, preferably from 400 to 1200 Pa·s.

Preferably, the VDF copolymer has, before grafting, a Young's (tensile) modulus ranging from 200 to 1000 MPa, preferably from 200 to 600 MPa.

The invention also relates to a blend comprising this modified copolymer and a PVDF. This modified copolymer or the blend may be combined with a thermoplastic polymer, an elastomer or an inorganic material.

### DETAILED DESCRIPTION OF THE INVENTION

Regarding the PVDF on which the grafting is carried out, this is a copolymer of VDF (vinylidene fluoride, CH₂═CF₂) the weight content of which is at least 50%, preferably at least 75%, and of at least one monomer that is copolymerizable with the VDF. The comonomer may be, for example, vinyl fluoride (VF), trifluoroethylene, chlorotrifluoroethylene (CTFE), 1,2-difluoroethylene, tetrafluoroethylene (TFE), hexafluoropropene (HFP), 3,3,3-trifluoropropene and 2-trifluoromethyl-3,3,3-trifluoro-1-propene. Preferably, for reasons of ease of extrusion, it is a thermoplastic PVDF.

VDF-HFP copolymers are preferred, of which the HFP weight content varies from 4 to 22%, preferably from 10 to 20% (content calculated before grafting of the unsaturated polar monomer).

PVDF has, in addition, the following characteristics (before undergoing grafting):
a crystallization temperature T_{c} (measured by DSC according to the standard ISO 11357-3) ranging from 50 to 120° C., preferably from 85 to 110° C.;
a yield strength σ_{Y} (measured at 20° C.) ranging from 10 to 40 MPa, preferably from 10 to 30 MPa; and
a melt viscosity η (measured with a capillary rheometer at 230° C. and 100 s⁻¹) ranging from 100 to 1500 Pa·s, preferably from 400 to 1200 Pa·s.

It also has, before grafting, a Young's (tensile) modulus (ASTM D-638) that ranges preferably from 200 to 1000 MPa, preferably from 200 to 600 MPa.

In relation to the grade KYNARFLEX® 2801 that is described in EP 1 508 927, the PVDF that is modified has, at the start, a lower viscosity η, which means that after the modification, the viscosity of the functionalized PVDF is also lower than the modified KYNARFLEX® 2801. This facilitates the use of the functionalized PVDF whether it is in the melt state or else in solution in a solvent.

The functionalized PVDF or the blend has, relative to the functionalized PVDFs of the prior art, the following advantages:
a stronger adhesion to polymers and inorganic materials;
a greater ease of use whether they are in the melt state or in solution in a solvent; and
they allow a greater coextrusion speed.

The grades KYNARFLEX® 2500 and 2750 sold by ARKEMA are examples of PVDF that are suitable for the invention:

### Characteristics of KYNARFLEX® 2500

VDF-HFP copolymer having 19% of HFP;

T_{c}: 87.4° C.

σ_{Y}: 15 MPa

η: 1000 Pa·s and

Young's (tensile) modulus: 220 MPa.

### Characteristics of KYNARFLEX® 2750

VDF-HFP copolymer having 16% of HFP

T_{c}: 103° C.

σ_{Y}: 18 MPa

η: 900 Pa·s

Young's (tensile) modulus: 360 MPa.

Regarding the functionalized PVDF, this is obtained by radiation grafting at least one unsaturated polar monomer onto the PVDF defined above. This will subsequently be referred to as functionalized PVDF.

The method comprises the following steps:

a). the PVDF is firstly blended with at least one unsaturated polar monomer by any melt-blending technique known in the prior art. The blending step is carried out in any mixing device such as extruders or kneaders used in the thermoplastics industry. Preferably, an extruder will be used to convert the blend into granules. Grafting therefore takes place on a blend (in the bulk) and not at the surface of a powder as is described, for example, in document U.S. Pat. No. 5,576,106. The proportion of PVDF is, by weight, between 80 and 99.9%, preferably from 90 to 99% per 0.1 to 20%, preferably 1 to 10%, respectively of the unsaturated polar monomer.
b). Next, the blend is irradiated β or γ radiation) in the solid state using an electron or photon source with a radiation dose between 10 and 200 kGray, preferably between 10 and 150 kGray. The blend may, for example, be packaged in polythene bags, the air expelled, and then the bags sealed. Advantageously the dose is between 2 and 6 Mrad and preferably between 3 and 5 Mrad. Irradiation using a cobalt-60 bomb is particularly preferred.

The amount of unsaturated polar monomer that is grafted is between, by weight, 0.1 and 5% (that is to say that the unsaturated polar monomer grafted corresponds to 0.1 to 5 parts per 99.9 to 95 parts of PVDF), advantageously from 0.5 to 5%, preferably from 0.9 to 5%. This amount depends on the initial amount of unsaturated polar monomer in the blend to be irradiated. It also depends on the effectiveness of the grafting, therefore on the duration and the energy of the irradiation.

c). The unsaturated polar monomer that has not been grafted and also the residues released by the grafting, especially HF, may then be optionally removed. This last step may be made necessary if the ungrafted unsaturated polar monomer is likely to destroy the adhesion, or else for toxicology problems. This operation may be carried out according to the techniques known to a person skilled in the art. Vacuum degassing may be applied, optionally at the same time as heating. It is also possible to dissolve the functionalized PVDF in a suitable solvent such as, for example, N-methylpyrrolidone, then to precipitate it into a non-solvent, for example into water or else into an alcohol, or else to wash the functionalized PVDF using a solvent that is inert with regard to the fluoropolymer and the grafted functional groups. For example, when maleic anhydride is grafted, it may be washed with chlorobenzene.

This is one of the advantages of this radiation grafting method, being able to obtain higher contents of grafted unsaturated polar monomer than with the conventional grafting methods using a radical initiator. Thus, typically, with the radiation grafting method it is possible to obtain contents greater than 1% (1 part of unsaturated monomer per 99 parts of PVDF), even greater than 1.5%, which is not possible with a conventional grafting method in an extruder.

On the other hand, the radiation grafting is carried out “cold”, typically at temperatures below 100° C., even below 50° C., so that the blend to be irradiated is not in the melt state as for a conventional grafting method in an extruder. One essential difference is that the grafting takes place in the amorphous phase and not in the crystalline phase, whereas a homogenous grafting is produced in the case of grafting in an extruder in the melt state. The unsaturated polar monomer is therefore not distributed over the PVDF chains in the same way in the case of radiation grafting as in the case of grafting in an extruder. The functionalized PVDF therefore has a different distribution of the unsaturated polar monomer over the PVDF chains relative to a product that would be obtained by grafting in an extruder.

During this grafting step, it is preferable to avoid the presence of oxygen. Nitrogen or argon flushing of the blend to be irradiated is therefore possible for removing the oxygen. The functionalized PVDF has the very good chemical and oxidation resistance as well as the good thermomechanical behaviour of the PVDF before its modification.

Regarding the unsaturated polar monomer, this has a C═C double bond and also at least one polar group which may be one of the following functional groups:
carboxylic acid;
carboxylic acid salt;
carboxylic acid anhydride;
epoxide;
carboxylic acid ester;
silyl;
alkoxysilane;
carboxylic acid amide;
hydroxy; or
isocyanate.
   Mixtures of several unsaturated monomers are also conceivable.

Unsaturated carboxylic acids having 4 to 10 carbon atoms and their functional derivatives, particularly their anhydrides, are particularly preferred unsaturated monomers. As examples of unsaturated monomers, mention may be made of methacrylic acid, acrylic acid, maleic acid, fumaric acid, itaconic acid, citraconic acid, undecylenic acid, allylsuccinc acid, 4-cyclohexane-1,2-dicarboxylic acid, 4-methyl-4-cyclohexene-1,2-dicarboxylic acid, bicyclo[2.2.1]hept-5-ene-2,3-dicarboxylic acid, x-methylbicyclo[2.2.1]hept-5-ene-2,3-dicarboxylic acid, zinc, calcium or sodium undecylenate, maleic anhydride, itaconic anhydride, citraconic anhydride, dichforomaleic anhydride, difluoromaleic anhydride, crotonic anhydride, glycidyl acrylate or methacrylate, allyl glycidyl ether, vinylsilanes such as vinyltrimethoxysilane, vinyltriethoxysilane, vinyitriacetoxysilane, and γ-methacryloxypropyltrimethoxysilane.

Other examples of unsaturated monomers include C₁-C₈ alkyl esters or glycidyl ester derivatives of unsaturated carboxylic acids such as methyl acrylate, methyl methacrylate, ethyl acrylate, ethyl methacrylate, butyl acrylate, butyl methacrylate, glycidyl acrylate, glycidyl methacrylate, monoethyl maleate, diethyl maleate, monomethyl fumarate, dimethyl fumarate, monomethyl itaconate, and diethyl itaconate; amide derivatives of unsaturated carboxylic acids such as acrylamide, methacrylamide, maleamide, malediamide, N-ethylmaleamide, N,N-diethylmaleamide, N-butylmaleamide, N,N-dibutylmaleamide, fumaramide, fumardiamide, N-ethylfumaramide, N,N-diethylfumaramide, N-butylfumaramide and N,N-dibutylfumaramide; imide derivatives of unsaturated carboxylic acids such as maleimide, N-butylmaleimide and N-phenylmaleimide; and metal salts of unsaturated carboxylic acids such as sodium acrylate, sodium methacrylate, potassium acrylate, potassium methacrylate and zinc, calcium or sodium undecylenate.

Preferably, the unsaturated monomer does not have more than one C═C double bond, as this leads to crosslinking of the copolymer. Diacrylates or triacrylates are examples of unsaturated monomers having more than one C═C double bond. From this point of view, maleic anhydride and also the zinc, calcium and sodium undecylenates make good graftable compounds because they have a low tendency to homopolymerize or even to give rise to crosslinking.

Advantageously, maleic anhydride is used. This is because this monomer offers the following advantages:
it is solid and can easily be introduced with the fluoropolymer granules before the melt-blending;
being solid, it is also easier to handle (in particular it is not very volatile);
it enables good adhesion properties to be obtained;
it is particularly reactive towards many chemical functional groups; and
unlike other unsaturated monomers such as (meth)acrylic acid or acrylic esters, it does not homopolymerize and does not have to be stabilized.

The functionalized PVDF may be used alone or else in a blend with another PVDF, which may be a PVDF homopolymer or copolymer. Preferably, this other PVDF is chosen so that the two PVDFs are compatible and that the blend has only one DSC melting peak. Preferably, the other PVDF is a copolymer of VDF and at least one monomer that is copolymerizable with VDF having a VDF weight content of at least 50%, preferably at least 75%, and which has the same thermal and mechanical characteristics specified above. The blend comprises, by weight, from 1 to 99%, preferably from 50 to 99% of the functionalized PVDF per 99 to 1%, preferably 1 to 50%, respectively of another PVDF. The blend may be prepared in a molten medium using a blending tool suitable for thermoplastics, for example using an extruder.

### Uses of the Functionalized PVDF or of the Blend

The functionalized PVDF or the blend may be combined with a thermoplastic polymer, an elastomer or an inorganic material. The invention also relates to a multilayer structure comprising at least one layer consisting of at least one functionalized PVDF or the blend and:
at least one layer consisting of at least one thermoplastic polymer and/or at least one elastomer; and
at least one layer of an inorganic material.

For each multilayer structure of the present application, each layer is defined in the widest possible way by the expression “layer consisting of a polymer X”. The multilayer structure is also defined in parallel by “layer of polymer X”.

Multilayer Structure with a Layer of Thermoplastic Polymer

This structure may be prepared, for example, by the technique of coextrusion, rotomoulding or extrusion-blow moulding. It may take the form of a film, a tube, a container or a hollow body.

As examples of thermoplastic polymers, mention may be made of:
polyamides (for example, PA-6, PA-11, PA-12, PA-6,6, etc.);
polymers comprising ethylene or propylene as the major component (>50 wt %). Mention may be made, for example, of polyolefins (PE, PP) and also copolymers of ethylene and at least one comonomer of ethylene chosen from α-olefins, preferably butene or octene, vinyl esters of saturated carboxylic acids, preferably vinyl acetate or vinyl propionate, alkyl(meth)acrylates, preferably methyl, butyl or ethyl acrylate;
polymers based on vinyl chloride, such as PVC (flexible or rigid), chlorinated PVC(CPVC) or based on vinylidene chloride (e.g. PVDC);
ABS (acrylonitrile-butadiene-styrene copolymer) or SAN (styrene-acrylonitrile copolymer);
acrylic polymers, especially PMMA homopolymer or copolymer;
saturated polyesters (PET, PBT, PBN);
polycarbonates;
polyphenylene sulphide (PPS);
polyphenylene oxide (PPO);
EVOH (ethylene-vinyl alcohol copolymer);
polyetheretherketone (PEEK);
polyoxymethylene (acetal);
polyethersulphone;
polyurethanes;
polymers and copolymers based on styrene, especially high-impact or crystal polystyrene and also styrene-diene block copolymers of the SBS type;
fluoropolymers such as, for example, PVDF, PTFE, TFE/HFP copolymers, ethylene/TFE copolymers, ethylene/chlorotrifluoroethylene copolymers and polyvinyl fluoride.

The polyolefin may be a polyethylene of the type MDPE (medium density), HDPE (high density), LDPE (low density), LLDPE (linear low density), a polyethylene prepared by a metallocene, or more generally single-site, type catalysis or else a crosslinked polyethylene (PEX). It could be a homopolymer or copolymer. The copolymer could especially be a copolymer having a comonomer content greater than 5 wt %, for example an ethylene-octene copolymer of the ENGAGE® type. Mention may also be made of the olefin block copolymers (OBCs) recently developed by Dow under the trademark INFUSE® that comprise hard and soft blocks and which are prepared according to the teaching of applications WO 2005/090425, WO 2005/090426 and WO 2005/090427.

Included in the term thermoplastics are thermoplastic elastomers which, according to the definition proposed by the IUPAC in 2002, are melt-processable copolymers which have a continuous elastomeric phase reinforced by a dispersion of glassy or crystalline domains that act as junction points over a limited range of temperature. Among the thermoplastic elastomers, mention may most particularly be made of TPOs.

As examples of elastomers, mention may be made of:
polychloroprene;
nitrile rubbers (e.g. acrylonitrile-butadiene copolymer);
acrylic elastomers;
fluoroelastomers;
EPM and EPDM;
polyurethane elastomers; and
copolyetheramides and copolyesteramides (e.g. the PEBAX grades sold by Arkema).

For more details on the elastomers, reference can be made to Ullmann's Encyclopaedia of Industrial Chemistry, Vol. A23, 1993 edition, ISBN 3-527-20123-8, pp. 239-334.

When the adhesion between the layer of the functionalized PVDF or of the blend and the layer of thermoplastic polymer or elastomer is not sufficient, at least one adhesive tie layer may be placed between these two layers. The adhesive tie has advantageously chemical functional groups that react with those present on the functionalized PVDF. For example, if acid anhydride functional groups have been grafted onto the PVDF, the adhesive tie advantageously comprises epoxide or hydroxyl functional groups. The adhesive tie layer may possibly be divided into two. That is to say that a first tie layer and a second different tie layer may be placed between the layer of thermoplastic polymer and the layer of the functionalized PVDF or of the blend, the two tie layers being placed against each other.

As an example of the multilayer structure, mention may be made of that comprising, placed in order against each other:
one layer comprising at least one thermoplastic polymer and/or at least one elastomer;
optionally at least one adhesive tie layer;
a layer comprising the functionalized PVDF or the blend; and
optionally one layer comprising a fluoropolymer, preferably a PVDF homopolymer or copolymer.

In the case of a tube or pipe, container or hollow body, the thermoplastic polymer layer is the outer layer or the inner layer. An example of such a structure is that for which the thermoplastic polymer is a polyethylene, which is in the form of a pipe or a container and which is used to transport or store a chemical capable of damaging the polyolefin, the polyethylene layer being the outer layer. The chemical may be, for example, a hydrocarbon (petrol, fuel, etc.) or a corrosive product (acid, base, hydrogen peroxide, etc.). The layer of functionalized PVDF or of the blend and/or the fluoropolymer layer makes it possible to protect the polyolefin layer. In the case of a hydrocarbon, it prevents the polyolefin from swelling.

Another example of a multilayer structure comprises, placed in order against each other:
optionally one layer comprising a fluoropolymer, preferably a PVDF homopolymer or copolymer;
a layer comprising the functionalized PVDF or the blend;
optionally at least one adhesive tie layer;
one layer comprising at least one thermoplastic polymer and/or at least one elastomer;
optionally at least one adhesive tie layer;
a layer comprising the functionalized PVDF or the blend;
optionally one layer comprising a fluoropolymer, preferably a PVDF homopolymer or copolymer.

An example of such a structure is that for which the thermoplastic polymer is a polyethylene, which is in the form of a pipe or a container and which is used to transport or store a chemical capable of damaging the polyolefin. The chemical may be, for example, a hydrocarbon (petrol, fuel, etc.) or a corrosive product (acid, base, hydrogen peroxide, etc.). The layers of functionalized PVDF or of the blend and/or the optional fluoropolymer layers have the role of protecting the internal polyethylene layer. In the case of a hydrocarbon, they also prevent the polyethylene from swelling.

Multilayer Structure with a Layer of Inorganic Material

The term “inorganic material” is understood to mean:
a metal;
glass;
concrete;
silicon; or
quartz.

The layer comprising the functionalized PVDF or the blend therefore forms a protective coating for the inorganic material. In other words, the inorganic material is coated by a composition comprising at least one functionalized PVDF or the blend according to the invention. This composition protects, for example, against corrosion in all its forms. It may also optionally comprise at least one acrylic polymer, for example a PMMA. It may also optionally comprise one or more additives chosen from UV stabilizers, mineral fillers, pigments and/or dyes, conductive fillers such as carbon black or carbon nanotubes, etc.

The metal may be, for example, iron, copper, aluminium, titanium, lead, tin, cobalt, silver, tungsten, nickel, zinc or an alloy (for example steel, or carbon, nickel, chromium, nickel-chromium, chromium-molybdenum or silicon steels, stainless steel, cast iron, Permalloy, aluminium-magnesium, aluminium-silicon, aluminium-copper-nickel-magnesium or aluminium-silicon-copper-nickel-magnesium alloys, brass, bronze, silicon bronze, silicon brass, or nickel bronze).

The metal may first undergo a physical and/or chemical pretreatment, the aim of which is to clean the metal surface and to promote the adhesion of the layer of functionalized PVDF or of the blend. The possible pretreatments are the following: alkaline cleaning, cleaning with solvents such as trichloroethylene, brushing, shot peening, phosphating, chromating, anodizing (for example for aluminium and its alloys), chromic anodizing, silanizing, abrasion, pickling and especially sulphochromic pickling. One possible pretreatment could consist in applying an adhesion promoter. Adhesion promoters have been described by P. E. Cassidy in the review Ind. Eng. Chem. Prod. Res. Development, 1972, Volume 11, N^{o} 2, p. 170-177 or by A. J. Kinlock in J. Mat. Sci., 1980, 15, p. 2141-66. Mention may be made, as examples of possible chemical pretreatments, of Alodine NR1453, Alodine NR2010, Accomet C or Safeguard 6000. The pretreatment could also consist of a combination of these various pretreatments, especially the combination of a physical and chemical pretreatment.

The metal may be in various shapes and geometries such as for example in the form of:
an extended surface such as, for example, a sheet, a plate or a foil;
a hollow body such as, for example, a vessel, a container, a bottle, a cylinder or a chemical reactor;
a tube or pipe, a bend, a valve, a needle valve or a pump;
a wire, strand, cable or guy rope; or
an electrode.

The coating may be applied in the melt state, in solution in a solvent or in powder form. In the case of a powder, the fluidized bed technique may be used, which consists in dipping a heated metal part into a fluidized bed of the powder, or else the electrostatic powder-coating technique may be used. The powder is introduced into a spray gun where it is transported by compressed air and passes through a nozzle raised to a high electrical potential, generally between about ten and about one hundred kV. The applied voltage may be of positive or negative polarity. The powder flow rate through the spray gun is generally between 10 and 200 g/min, preferably between 50 and 120 g/min. During its passage through the nozzle, the powder becomes charged with a certain amount of electricity and the powder particles transported by the compressed air are applied onto the metal part which is earthed, that is to say at a zero electrostatic potential. The powder particles are retained on this surface by their electrostatic charge and the electrostatic attraction forces are sufficient for the object coated with the powder to be moved and heated in an oven.

### Use in the Field of Electrodes

The functionalized PVDF or the blend may be used in the manufacture of positive or negative electrodes, in particular for lithium-ion batteries. The electroactive layer containing either mixed oxide fillers or carbon and/or graphite fillers and also other ingredients to control the electrical properties, is produced, in general, by dispersing the fillers in a solvent in the presence of a fluoropolymer binder. The dispersion is then deposited onto a metal collector by a casting method, the solvent is then evaporated to obtain a negative or positive electrode depending on the type of filler used. The performance of a battery strongly depends on the characteristics of the binder. A good binder makes it possible to produce layers sufficiently filled with electroactive ingredients, which makes it possible to have a high specific capacity. The binder must also be stable with respect to oxidization-reduction reactions during charge/discharge cycles and must also be unaffected by the electrolyte present in the battery. The electrolyte typically contains carbonate-type solvents (ethyl or propylene carbonate) and a lithium salt (LiPF₆, LiBF₄). Reference can be made to EP 1 508 927, US 2003/0072999, US 2003/0232244 and, U.S. Pat. No. 5,460,904 for further details on fluoropolymer binders. In Examples 2 and 3 of EP 1 508 927 A2, the functionalized PVDF could especially be replaced with the functionalized PVDF or the blend of the invention.

The invention also relates to the use of the functionalized PVDF or the blend according to the invention for manufacturing a positive or negative electrode of a battery, preferably a lithium-ion battery.

It also relates to a positive or negative electrode for a lithium-ion battery comprising the structure composed of:
one layer of a metal L₁; and
one layer L₂ comprising the functionalized PVDF or the blend of the invention.

The metal is preferably aluminium for a positive electrode and copper for a negative electrode.

### Coextrusion Process

The Applicant has observed that it is possible, with the coextrusion technique in which at least one layer comprising the functionalized PVDF or the blend and at least one layer of a thermoplastic polymer are coextruded, to increase the coextrusion line speed (that is to say the speed of the coextruded multilayer structure in m/min) without harming the quality of the adhesion between the layer of the functionalized PVDF (or of the blend) and the layer or layers in contact with it.

The invention also relates to with the coextrusion process using the functionalized PVDF or the blend, consisting in coextruding at least one layer of the functionalized PVDF or of the blend and at least one layer of a thermoplastic polymer or an elastomer.

### EXAMPLES

### Products Used

KYNAR® 720: PVDF homopolymer from Arkema with a melt flow index of 20 g/10 min (230° C./5 kg) and a melting point of 170° C., having the following characteristics:
T_{c}: 135° C.
σ_{Y}: 55 MPa
η: 900 Pa s (230° C., 100 s⁻¹); and
Young's modulus: 2200 MPa.

OREVAC® 18302: LLDPE-type polyethylene, onto which maleic anhydride is grafted, with a melt flow index of 1 g/10 min and a melting point of 124° C.

LOTADER® AX 8840: copolymer of ethylene (92 wt %) and glycidyl methacrylate (8 wt %) from Arkema having a melt flow index of 5 according to ASTM D-1238.

PEX: obtained from a blend of 95 wt % of BORPEX® ME-2510 and 5% of MB-51, two products sold by Borealis. Crosslinking is carried out by heating and is due to the presence of silane functional groups on the polyethylene.

PVDF-1: VDF-HFP copolymer having 16 wt % of HFP, with:
T_{c}: 103° C.;
σ_{Y}: 18 MPa;
η: 900 Pa·s; and
Young's (tensile) modulus: 360 MPa.

### Example 1

### Preparation of a Functionalized PVDF

In a Werner 40-type extruder, PVDF-1 was blended at 190° C. with 2 wt % maleic anhydride. This blending was carried out with all the extruder vents closed, with a screw speed of 200 rpm and a throughput of 60 kg/h.

The product that was granulated into rods was introduced into a bag having an impermeable aluminium layer. This bag was irradiated with 20 kGray. After irradiation, the product was again passed into the extruder at 245° C., under maximum vacuum and at 200 rpm. The throughput was 25 kg/h. Infrared analysis of the product after this devolatilization step showed a degree of grafting of 0.31% and an amount of free maleic anhydride of 300 ppm. This product was called functionalized PVDF 1.

### Example 2

### Preparation of a Functionalized PVDF

The conditions of Example 1 were repeated, but with KYNAR® 720 instead of the PVDF-1. The infrared analysis of the product after devolatilization showed a degree of grafting of 0.50% and an amount of free maleic anhydride of 300 ppm. This product was called functionalized PVDF 2.

### Example 3 (Comparative)

Using a McNeil extruder, a multilayer tube (outside diameter: 14 mm) was manufactured, having the following structure:

KYNAR® 720 (130 μm)/functionalized PVDF 2 (50 μm)/LOTADER® AX 8840 (50 μm)/PEX (780 μm).

The PEX layer was the outer layer. All the layers adhered to each other. The extrusion was carried out at 40 m/minute under the following conditions:
PE layer: 230° C.
LOTADER® AX 8840: 250° C.
Functionalized PVDF: 250° C. and
KYNAR® 720: 250° C.

The adhesion between the functionalized PVDF and LOTADER® 8840 layers, five days after the extrusion, was measured to be 10 N/cm in circumferential peel. The adhesion was of the adhesive failure type.

### Example 4 (Comparative)

Under the same conditions as in Example 3, a tube was manufactured having the following structure:

KYNAR® 720 (130 μm)/functionalized PVDF 2 diluted to 50% in a VDF-HFP copolymer containing 16% of HFP and having a viscosity at 230° C. of 900 Pa·s at 100 s⁻¹ (50 μm)/LOTADER® AX 8840 (50 μm)/PEX (780 μm).

The extrusion was carried out at 40 m/minute. The PEX layer was the outer layer. All the layers adhered to each other. The adhesion between the PVDF blend and LOTADER® 8840 layers was measured to be 20 N/cm by circumferential peel after 5 days. The adhesion was of the adhesive failure type.

### Example 5

### According to the Invention

Under the same conditions as in Example 3, a tube was manufactured having the following structure:

KYNAR® 720 (130 μm)/functionalized PVDF 1 (50 μm)/LOTADER® AX 8840 (50 μm)/PEX (780 μm).

The extrusion was carried out at 40 m/minute. The adhesion was measured to be 60 N/cm by circumferential peel after 5 days. The adhesion was of the cohesive failure type in the LOTADER® 8840 layer.

TABLE I

| | Nature of X in a KYNAR ® 720/X/ | | |
|---|---|---|---|
| | LOTADER ® AX 8840/PEX | | |
| Ex. | structure | Adhesion | |
| 3 (comp.) | Functionalized PVDF 2 | Adhesive | 10 N/cm |
| 4 (comp.) | Functionalized PVDF 2 diluted to | Adhesive | 20 N/cm |
| | 50% in VDF-HFP copolymer (16% | | |
| | of HFP, viscosity at 230° C. of 900 | | |
| | Pa · s at 100 s⁻¹) | | |
| 5 (inv.) | Functionalized PVDF 1 | Cohesive | 60 N/cm |

In the structures from Examples 3 to 5, the LOTADER® AX 8840 is used as an adhesive tie between the functionalized PVDF and the PEX.

### Example 6

### According to the Invention

A film was manufactured, on a Collin bubble extruder, having the following structure:

KYNAR® 2500-20 (50 μm)/functionalized PVDF 1 (25 μm)/EVOH (25 μm)/OREVAC® 18302 (10 μm)/PE (140 μm).

The extrusion was carried out at 230° C. on a film of 250 μm total thickness. The adhesion was measured to be 18 N/cm between the functionalized PVDF 1 and EVOH.

### Example 7 (Comparative)

A film was manufactured, on a Collin bubble extruder, having the following structure:

KYNAR® 2500-20 (50 μm)/functionalized PVDF 2 (25 μm)/EVOH (25 μm)/OREVAC® 18302 (10 μm)/PE (140 μm).

The extrusion was carried out at 230° C. on a film of 250 μm total thickness. The adhesion was measured to be 0.5 N/cm between the functionalized PVDF 1 and EVOH.

TABLE 2

| | Nature of X in a KYNAR ® | |
|---|---|---|
| | 2500-20/X/EVOH/ | |
| | OREVAC ® 18302/PE | |
| Ex. | structure | Adhesion |
| 5 (inv.) | Functionalized PVDF 1 | 18 N/cm |
| 6 (comp.) | Functionalized PVDF 2 | 0.5 N/cm |

1. Copolymer of vinylidene fluoride (VDF) and at least one monomer that is copolymerizable with VDF, having a VDF weight content of at least 50%, preferably at least 75%, onto which at least one unsaturated polar monomer is radiation grafted, wherein the VDF copolymer has, before grafting, the following characteristics:
a crystallization temperature T_{c} (measured by DSC according to the standard ISO 11357-3) ranging from 50 to 120° C.;
a yield strength σ_{Y} ranging from 10 to 40 MPa; and
a melt viscosity η (measured with a capillary rheometre at 230° C. and 100 s⁻¹) ranging from 100 to 1500 Pa·s.

2. Copolymer according to claim 1, wherein the VDF copolymer has, before grafting, a Young's (tensile) modulus ranging from 200 to 1000 MPa.

3. Copolymer according to claim 1, wherein the VDF comonomer is selected from the group consisting of vinyl fluoride (VF), trifluoroethylene, chlorotrifluoroethylene (CTFE), 1,2-difluoroethylene, tetrafluoroethylene (TFE), hexafluoropropene (HFP), 3,3,3-trifluoropropene and 2-trifluoromethyl-3,3,3-trifluoro-1-propene.

4. Copolymer according to claim 1, wherein the VDF copolymer is a VDF-HFP copolymer that has, before grafting, a hexafluoropropene (HFP) weight content ranging from 4 to 20%

5. Copolymer according to claim 1, wherein said radiation grafting comprises
melt-blending of said VDF copolymer with at least one unsaturated polar monomer;
irradiating said melt blend in the solid state using electron or photon radiation with a radiation dose between 10 and 200 kGray; and
optionally removing the ungrafted unsaturated polar monomer and the residues released by the grafting.

6. Blend of at least one copolymer of claim 1 and at least one PVDF homopolymer or copolymer.

7. Blend according to claim 6, wherein a weight proportion of 50 to 99% of the copolymer onto which the unsaturated polar monomer has been grafted, per 1 to 50% respectively of a PVDF homopolymer or copolymer.

8. Blend according to claim 6, wherein the PVDF is compatible with the copolymer onto which the unsaturated polar monomer has been grafted and having only a single DSC melting peak.

9. (canceled)

10. (canceled)

11. Multilayer structure comprising at least one layer consisting of the copolymer as defined in claim 1 and:
at least one layer consisting of at least one thermoplastic polymer and/or at least one elastomer; and
at least one layer of an inorganic material.

12. Multilayer structure of claim 11 comprising, placed in order against each other:
one layer comprising at least one thermoplastic polymer and/or at least one elastomer;
optionally at least one adhesive tie layer;
one layer comprising the copolymer as defined in claim 1; and
optionally one layer comprising a fluoropolymer, preferably a PVDF homopolymer or copolymer.

13. Multilayer structure of claim 11 comprising, placed in order against each other:
optionally one layer comprising a PVDF homopolymer or copolymer;
one layer comprising the copolymer as defined in claim 1;
optionally at least one adhesive tie layer;
one layer comprising at least one thermoplastic polymer and/or at least one elastomer;
optionally at least one adhesive tie layer;
one layer comprising the copolymer as defined in claim 1; and
optionally one layer comprising a PVDF homopolymer or copolymer.

14. Multilayer structure according to claim 11 wherein the thermoplastic polymer is chosen from:
polyamides;
polymers comprising more than 50 wt % of ethylene and/or of propylene;
polymers comprising more than 50 wt % of vinyl chloride;
ABS (acrylonitrile-butadiene-styrene copolymer) or SAN (styrene-acrylonitrile copolymer);
acrylic polymers;
saturated polyesters;
polycarbonates;
polyphenylene sulphide (PPS);
polyphenylene oxide (PPO);
EVOH (ethylene-vinyl alcohol copolymer);
polyetheretherketone (PEEK);
polyoxymethylene (acetal);
polyethersulphone;
polyurethanes;
polymers and copolymers comprising more than 50 wt % of styrene; and
fluoropolymers.

15. Multilayer structure according to claim 11 wherein the thermoplastic polymer is a polyolefin or a copolymer of ethylene and at least one comonomer of ethylene selected from the group consisting of α-olefins, butane, octene, vinyl esters of saturated carboxylic acids, vinyl acetate, vinyl propionate, alkyl(meth)acrylates, methyl acrylate, butyl acrylate, and ethyl acrylate.

16. Multilayer structure according to claim 15, wherein the polyolefin is a polyethylene homopolymer or copolymer of the MDPE (medium density) type, a HDPE (high density), an LDPE (low density), an LLDPE (linear low density), a polyethylene prepared by metallocene, or a crosslinked polyethylene (PEX).

17. Multilayer structure according to claim 11 in the form of a film, a tube or pipe, a container or a hollow body.

18. A protectively coated inorganic material comprising:
the VDF copolymer of claim 1;
optionally at least one acrylic polymer; and
an inorganic material.

19. The protectively coated inorganic material according to claim 18, wherein the inorganic material is:
a metal;
glass;
concrete;
silicon; or
quartz.

20. (canceled)

21. Positive or negative electrode for a lithium-ion battery comprising the structure composed of:
one layer of a metal L₁; and
one layer L₂ comprising the modified copolymer according to claim 1.

22. Electrode according to claim 21, wherein the metal is aluminium or copper.

23. The copolymer of claim 1, wherein the VDF copolymer has, before grafting, the following characteristics:
a crystallization temperature T_{c} (measured by DSC according to the standard ISO 11357-3) ranging from 85 to 110° C.;
a yield strength σ_{Y} ranging from 10 to 30 MPa;
a melt viscosity η (measured with a capillary rheometre at 230° C. and 100 s⁻¹) ranging from 400 to 1200 Pa·s; and
a Young's (tensile) modulus ranging from 200 to 600 MPa.

24. Copolymer according to claim 4, wherein the VDF copolymer is a VDF-HFP copolymer that has, before grafting, a HFP weight content ranging from 10 to 20%.
Multilayer structure according to claim 14 wherein said polyamide is PA-6, PA-11, PA-12 or PA-6,6; wherein said saturated polyester is polyethylene terephthalate (PET), or polybutylene terephthalate (PBT); and wherein said fluoropolymer is polyvinylidene fluoride (PVDF), polytetrafluorethylene (PTFE), a tetrafluoroethylene/hexafluoropropene (TFE/HFP) copolymer; ethylene/TFE copolymers, ethylene/chlorotrifluoroethylene copolymers; or polyvinyl fluoride.
